(19) United States
(12) Patent Application Publication
(10) Pub. No.: US 2025/0168670 A1
(43) Pub. Date: May 22, 2025

(54) METHOD AND APPARATUS FOR TRANSMITTING MEASUREMENT CONFIGURATION INFORMATION, AND READABLE STORAGE MEDIUM

(71) Applicant: Beijing Xiaomi Mobile Software Co., Ltd., Beijing (CN)

(72) Inventor: Ting FU, Beijing (CN)

(21) Appl. No.: 18/842,761

(22) PCT Filed: Mar. 3, 2022
(86) PCT No.: PCT/CN2022/079140

§ 371 Date: Aug. 29, 2024

(51) Int. Cl. H04W 24/08; H04W 56/00; H04W 72/0446; H04W 72/0453

(52) U.S. Cl. CPC H04W 24/08; H04W 56/001; H04W 72/0446; H04W 72/0453

(57) ABSTRACT

A method for transmitting measurement configuration information, includes: receiving measurement configuration information transmitted by a second network device, where the measurement configuration information includes indication information, which is configured to indicate that a to-be-measured synchronization signal and PBCH block (SSB) does not include a physical broadcast channel (PBCH), or the indication information is configured to indicate that a to-be-measured SSB includes a first PBCH, with the amount of information included in and the first PBCH includes less information than a second PBCH.

### TECHNICAL FIELD

The disclosure relates to a radio communication technology field, and particularly relates to a method and apparatus for transmitting measurement configuration information, and a readable storage medium.

### BACKGROUND OF THE INVENTION

A synchronization signal and physical broadcast channel (PBCH) block (SSB) in a 5th-generation (5G) new radio (NR) communication system is composed of primary synchronization signals (PSSs), secondary synchronization signals (SSSs), and a PBCH. Some necessary information required by a terminal for initial access is carried in the PBCH, for instance, position information of a Type #0 common search space (CSS) in a time-frequency domain.

In 5G NR, a base station needs to broadcast SSBs periodically, and some SSBs broadcast by the base station are used for measurement instead of initial access. How to reduce energy consumption of broadcasting the SSBs by the base station is a technical problem to be solved.

### SUMMARY OF THE INVENTION

The disclosure provides a method and apparatus for transmitting measurement configuration information, and a readable storage medium.

A first aspect provides a method for receiving measurement configuration information. The method is performed by user equipment. The method includes:
receiving measurement configuration information transmitted by a second network device. The measurement configuration information includes indication information. The indication information is configured to indicate that a to-be-measured synchronization signal and PBCH block (SSB) does not include a physical broadcast channel (PBCH), or, the indication information is configured to indicate that a to-be-measured SSB includes a first PBCH. The first PBCH includes less information than a second PBCH.

In the method, on a condition that the to-be-measured SSB used by a first network device for SSB broadcasting does not include the PBCH or only includes the first PBCH, the first network device notifies the second network device of the situation, and the measurement configuration information is transmitted to the user equipment by the second network device, such that the user equipment receives the to-be-measured SSB and then measures one or more to-be-measured cells under the first network device according to a characteristic of the to-be-measured SSB. Compared with a case that the to-be-measured SSB used by the first network device for SSB broadcasting includes the second PBCH, in the disclosure, the first network device can be prevented from broadcasting some unnecessary information, and energy consumption of the first network device can be reduced.

In some possible embodiments, the measurement configuration information includes one or more pieces of the indication information. One piece of the indication information corresponds to one to-be-measured cell.

In some possible embodiments, the method further includes:
measuring SSBs corresponding to all SSB indexes in an SS/PBCH block measurement time configuration (SMTC) window. The SSB is an SSB on a to-be-measured cell corresponding to the indication information.

In some possible embodiments, the method further includes:
determining, on a condition that the indication information indicates that the to-be-measured SSB does not include the PBCH, that a primary synchronization signal (PSS) and a secondary synchronization signal (SSS) of the to-be-measured SSB occupy two consecutive symbols in a time domain.

In some possible embodiments, the indication information corresponds to one SSB frequency. The to-be-measured SSB is an SSB corresponding to the SSB frequency.

In some possible embodiments, the method further includes: measuring SSBs corresponding to all SSB indexes in an SMTC window. The SSB is an SSB at the SSB frequency.

In some possible embodiments, the first PBCH includes a system frame number (SFN) and an SSB index.

In some possible embodiments, the first PBCH occupies one or two symbols in a time domain.

In some possible embodiments, the method further includes:
ignoring the indication information on a condition that a frequency of the to-be-measured SSB is on a synchronization channel frequency grid, and determining that the to-be-measured SSB includes the second PBCH.

In some possible embodiments, the method further includes:
determining, on a condition that a frequency of the to-be-measured SSB is not on a synchronization channel frequency grid, that the to-be-measured SSB does not include the PBCH according to the indication information, or, determining that the to-be-measured SSB includes the first PBCH according to the indication information.

A second aspect provides a method for transmitting measurement configuration information. The method is performed by a second network device. The method includes:
transmitting measurement configuration information to user equipment. The measurement configuration information includes indication information. The indication information is configured to indicate that a to-be-measured synchronization signal and PBCH block (SSB) does not include a PBCH, or, the indication information is configured to indicate that a to-be-measured SSB includes a first PBCH. The first PBCH includes less information than a second PBCH.

In the method, the second network device is informed that the to-be-measured SSB used by a first network device for SSB broadcasting does not include the PBCH or only includes the first PBCH, and then the measurement configuration information is transmitted to the user equipment, such that the user equipment receives the to-be-measured SSB and then measures one or more to-be-measured cells under the first network device according to a characteristic of the to-be-measured SSB. Compared with a case that the to-be-measured SSB used by the first network device for SSB broadcasting includes the second PBCH, in the disclosure, the first network device can be prevented from broadcasting some unnecessary information, and energy consumption of the first network device can be reduced.

In some possible embodiments, the cell is a to-be-measured cell. The notification information includes an identifier of at least one measured cell.

In some possible embodiments, the notification information includes one SSB frequency. The at least one cell is at least one cell corresponding to the one SSB frequency.

In some possible embodiments, the first PBCH includes a system frame number (SFN) and an SSB index.

In some possible embodiments, the first PBCH occupies one or two symbols in a time domain.

A third aspect provides a communication apparatus. The communication apparatus may be configured to perform steps performed by user equipment according to the first aspect or any possible design of the first aspect. The user equipment may achieve all the functions of the above methods in a form of a hardware structure, a software module, or a combination of a hardware structure and a software module.

When the communication apparatus according to the first aspect is implemented by a software module, the communication apparatus may include a transceiver module.

The transceiver module is configured to receive measurement configuration information transmitted by a second network device. The measurement configuration information includes indication information. The indication information is configured to indicate that a to-be-measured synchronization signal and PBCH block (SSB) does not include a PBCH, or, the indication information is configured to indicate that a to-be-measured SSB includes a first PBCH. The first PBCH includes less information than a second PBCH.

A fourth aspect provides a communication apparatus. The communication apparatus may be configured to perform steps performed by a second network device according to the second aspect or any possible design of the second aspect. The second network device may achieve all the functions of the above methods in a form of a hardware structure, a software module, or a combination of a hardware structure and a software module.

When the communication apparatus according to the second aspect is implemented by a software module, the communication apparatus may include a transceiver module.

The transceiver module configured to transmit measurement configuration information to user equipment. The measurement configuration information includes indication information. The indication information is configured to indicate that a to-be-measured synchronization signal and PBCH block (SSB) does not include a physical broadcast channel (PBCH), or, the indication information is configured to indicate that a to-be-measured SSB includes a first PBCH. The first PBCH includes less information than a second PBCH.

A fifth aspect provides a communication apparatus. The communication apparatus includes a processor and a memory. The memory is configured to store a computer program. The processor is configured to execute the computer program, so as to implement the first aspect or any possible design of the first aspect.

A sixth aspect provides a communication apparatus. The communication apparatus includes a processor and a memory. The memory is configured to store a computer program. The processor is configured to execute the computer program, so as to implement the second aspect or any possible design of the second aspect.

A seventh aspect provides a computer-readable storage medium, which stores an instruction (also referred to as a computer program or program). When the instruction is invoked and executed in a computer, the computer is caused to execute the first aspect or any possible design of the first aspect.

An eighth aspect provides a computer-readable storage medium, which stores an instruction (also referred to as a computer program or program). When the instruction is invoked and executed in a computer, the computer is caused to execute the second aspect or any possible design of the second aspect.

It is to be understood that the above general description and the following detailed description are merely illustrative and explanatory, instead of limiting the disclosure.

### BRIEF DESCRIPTION OF DRAWINGS

The accompanying drawings described here serve to provide further understanding of examples of the disclosure and form part of the disclosure. Examples in the examples of the disclosure and their description serve to explain the examples of the disclosure and are not to be construed as unduly limiting the examples of the disclosure. In the drawings:

Accompanying drawings here are incorporated in the description as a constituent part of the description, illustrate examples conforming to examples of the disclosure, and serve to describe principles of the examples of the disclosure together with the description.

FIG. 1 is a schematic diagram of a framework of a radio communication system according to an example of the disclosure;

FIG. 2 is a schematic diagram of a method for transmitting measurement configuration information according to an example;

FIG. 3 is a structural diagram of an apparatus for receiving measurement configuration information according to an example;

FIG. 4 is a structural diagram of an apparatus for receiving measurement configuration information according to an example;

FIG. 5 is a structural diagram of an apparatus for transmitting measurement configuration information according to an example; and

FIG. 6 is a structural diagram of an apparatus for transmitting measurement configuration information according to an example.

### DETAILED DESCRIPTION OF THE INVENTION

Examples of the disclosure are further described with reference to accompanying drawings and specific embodiments.

Examples will be described in detail here and shown in the accompanying drawings illustratively. When the following descriptions involve the accompanying drawings, unless otherwise specified, the same number in different accompanying drawings denotes the same or similar elements. The embodiments described in the following examples do not denote all embodiments consistent with the examples of the disclosure. On the contrary, the embodiments are merely instances of an apparatus and a method consistent with some aspects of the disclosure as detailed in the appended claims.

The terms used in the examples of the disclosure are merely to describe the specific examples, instead of limiting the examples of the disclosure. The singular forms such as “a/an” and “the” used in the examples of the disclosure and the appended claims are also intended to include the plural forms, unless otherwise clearly stated in the context. It is to be further understood that the term “and/or” used here refers to and includes any of one or more of the associated listed items or all possible combinations.

It is to be understood that although the terms such as first, second and third may be used to describe various information in the examples of the disclosure, the information is not intended to be limited to the terms. The terms are merely used to distinguish the same type of information from each other. For instance, without departing from the scope of the examples of the disclosure, first information may also be referred to as second information, and similarly, second information may also be referred to as first information. Depending on the context, the words “if” and “under the condition” as used here can be interpreted as “when” or “at the time of” or “in response to determining”.

The examples of the disclosure are described in detail below, and the examples are illustratively shown in accompanying drawings, throughout which identical or similar reference numerals denote identical or similar elements. The examples described with reference to the accompanying drawings are illustrative and only intended to explain the disclosure, instead of limiting the disclosure.

As shown in FIG. 1, a method for transmitting a wake-up signal according to an example of the disclosure may be applied to a radio communication system 100. The radio communication system may include, but is not limited to, a network device 101 and user equipment 102. The user equipment 102 is configured to support carrier aggregation. The user equipment 102 may be connected to a plurality of carrier units of the network device 101, which include a primary carrier unit and one or more secondary carrier units.

It is to be understood that the radio communication system 100 may be applied to both a low-frequency scene and a high-frequency scene. Application scenes of the radio communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, a future evolved public land mobile network (PLMN) system, etc.

The above-mentioned user equipment 102 may be user equipment (UE), a terminal, an access terminal, a terminal unit, a terminal station, a mobile station (MS), a remote station, a remote terminal, a mobile terminal, a radio communication device, a terminal agent, user equipment, etc. The user equipment 102 may have a radio transceiving function, and may be in communication (for instance, radio communication) with one or more network devices 101 of one or more communication systems and receive a network service provided by the network device 101. The network device 101 here includes, but is not limited to, a base station illustrated.

The user equipment 102 may be a cell phone, a cordless phone, a session initiation protocol (SIP) phone, a wireless local loop (WLL) station, a personal digital assistant (PDA) device, a handheld device having a radio communication function, a computing device or other processing devices connected to a radio modem, a vehicular device, a wearable device, user equipment in a future 5G network, user equipment in a future evolved PLMN, etc.

The network device 101 may be an access network device (or an access network site). The access network device refers to a device providing a network access function, such as a radio access network (RAN) base station. The network device may specifically include a base station (BS) device, or include a base station device and a radio resource management device configured to control the base station device. The network device may further include a relay station (a relay device), an access point, a base station in the future 5G network, a base station in the future evolved PLMN, or an NR base station, etc. The network device may be a wearable device or a vehicular device. Alternatively, the network device may be a communication chip having a communication module.

For instance, the network device 101 includes, but is not limited to, gnodeB (gNB) in 5G, an evolved node B (eNB) in the LTE system, a radio network controller (RNC), a node B (NB) in a wideband code division multiple access (WCDMA) system, a radio controller in the CRAN system, a base station controller (BSC), a base transceiver station (BTS) in a GSM system or a code division multiple access (CDMA) system, a home base station (for instance, a home evolved nodeB or a home node B (HNB)), a baseband unit (BBU), a transmitting and receiving point (TRP), a transmitting point (TP), a mobile switching center, etc.

Some synchronization signal and PBCH blocks (SSBs) are only used for measurement instead of cell access, such that it is possible to transmit a primary synchronization signal (PSS) and a secondary synchronization signal (SSS) primarily during SSB transmission and not transmit a physical broadcast channel (PBCH), or transmit only a small amount of information in a PBCH.

An example of the disclosure provides a method for transmitting a wake-up signal. The method involves two network devices, including a first network device 101-1 and a second network device 101-2. The first network device 101-1 corresponds to a cell A, the second network device 101-2 corresponds to a cell B, and the cell A and the cell B are adjacent cells. When cell measurement is conducted by user equipment under the second network device 101-2, the cell A corresponding to the first network device 101-1 may be measured.

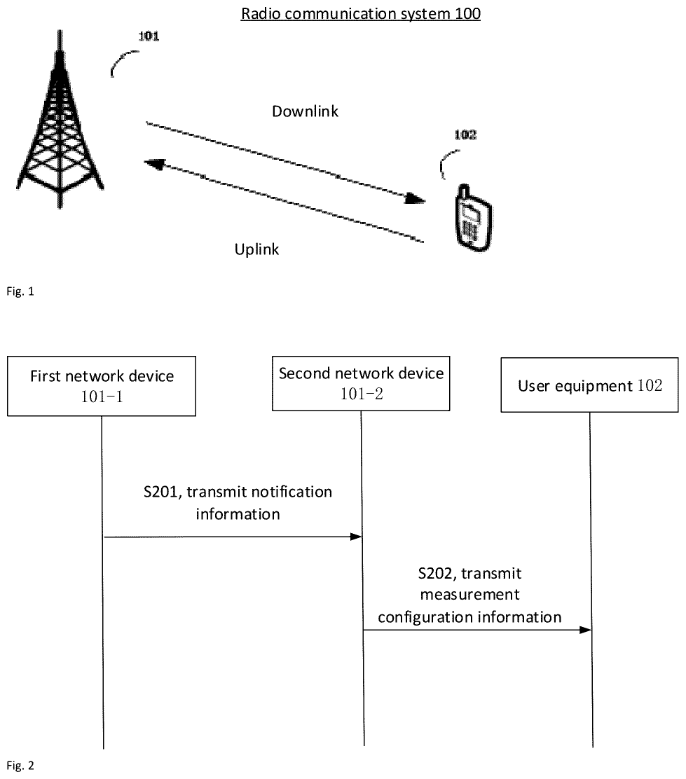

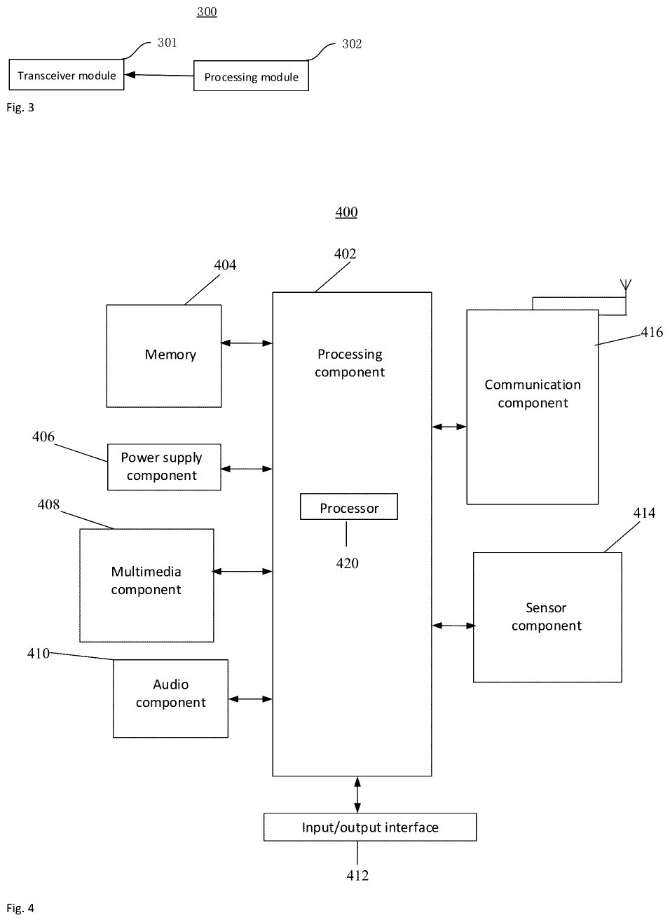

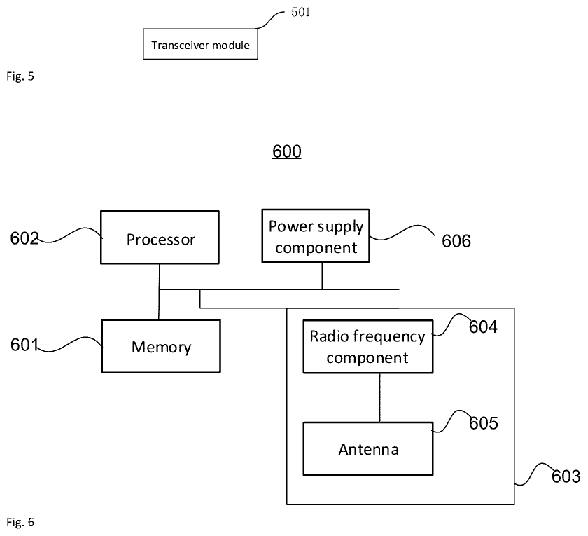

FIG. 2 is a flow diagram of a method for transmitting a wake-up signal according to an example. As shown in FIG. 2, the method includes S201-S202 specifically as follows:
S201, notification information is transmitted to a second network device 101-2 by a first network device 101-1.

The notification information transmitted to the second network device 101-2 by the first network device 101-1 is configured to indicate that an SSB on at least one cell or at one SSB frequency corresponding to the first network device does not include a PBCH, or, the notification information is configured to indicate that an SSB on at least one cell or at one SSB frequency corresponding to the first network device includes the first PBCH. The first PBCH includes less information than a second PBCH. The SSB frequency may also be referred to as an SSB frequency point.

The SSB does not include the PBCH as follows: the SSB does not include either the first PBCH or the second PBCH, or any information in the second PBCH.

The SSB includes the first PBCH as follows: the SSB only includes the first PBCH, and does not include other PBCHs such as the second PBCH.

For instance, the second PBCH is a PBCH in an NR R15/R16 protocol. The PBCH in the NR R15/R16 protocol, that is, the second PBCH, may occupy 56 bits, and includes at least the following information: master information block (MIB) information of 23 bits, a message extension spare of 1 bit, low 4 bits of a system frame number of 4 bits, a half frame indication of 1 bit, a physical layer spare of 2 bits and a frequency domain offset indication of 1 bit at an FR1 frequency, and high 4 bits of an SSB index of 3 bits at FR2 frequency.

It is to be noted that the SSB excluding the PBCH and the SSB including the first PBCH may be referred to as an abbreviated SSB.

In some possible embodiments, the first PBCH only includes a system frame number (SFN) and an SSB index. As timing information, the system frame number (SFN) may assist in achievement of a function of deriveSSB-IndexFromCell parameters, such that timing of an adjacent cell can be smoothly obtained through timing of a serving cell. The SSB index may assist in achievement of a function of SSB-ToMeasure parameters, such that a to-be-measured SSB can be accurately determined.

On a condition that an energy-saving mode is used for SSBs in some cells by the first network device 101-1, the notification information is transmitted to the second network device 101-2. After the notification information is received by the second network device 101-2, the second network device 101-2 may be informed that an SSB at one SSB frequency on at least one cell corresponding to the first network device 101-1 is an abbreviated SSB.

In some possible embodiments, the first PBCH occupies one or two symbols in a time domain. For instance, the second PBCH is a PBCH in an NR R15/R16 protocol. The second PBCH and its demodulation reference signal (DMRS) occupy 2nd, 3rd and 4th orthogonal frequency division multiplexing (OFDM) symbols of a synchronization broadcast block. The 2nd and 4th ODFM symbols are both occupied by the PBCH. On the 3rd symbol, the second PBCH is frequency-multiplexed with the SSS.

A number of symbols occupied by the first PBCH in a time domain is smaller than a number of symbols occupied by the second PBCH in a time domain, such that time domain resources can be further reduced, and energy consumption of the second network device can be reduced.

In some possible embodiments, the first network device 101-1 conducts indication through the notification information in one of the following modes:

A first mode is as follows: the cell is a to-be-measured cell, and the notification information includes an identifier of at least one measured cell.

A second mode is as follows: the notification information includes one SSB frequency, and the at least one cell is a cell corresponding to the one SSB frequency.

When indication is conducted by the first network device 101-1 through the notification information in the first mode, the second network device 101-2 may be informed about which SSB of the to-be-measured cell is an abbreviated SSB.

When indication is conducted by the first network device 101-1 through the notification information in the second mode, the second network device 101-2 may be informed about which to-be-measured SSB at the SSB frequency is an abbreviated SSB.

In some possible embodiments, the notification information further includes information indicating a type of an abbreviated SSB. For instance, when a value of the information is a first value, the first value is configured to indicate that the to-be-measured SSB does not include the PBCH, and when a value of the information is a second value, the second value is configured to indicate that the to-be-measured SSB includes the first PBCH, such that the second network device 101-2 is informed about the type of the abbreviated SSB, and the type can be applied to a scene where applicable.

S202, the measurement configuration information is transmitted to user equipment 102 by the second network device 101-1.

The measurement configuration information transmitted to the user equipment 102 by the second network device 101-1 includes indication information. The indication information is configured to indicate that a to-be-measured SSB does not include a PBCH, or, the indication information is configured to indicate that a to-be-measured SSB includes a first PBCH. The first PBCH includes less information than a second PBCH.

The SSB does not include the PBCH as follows: the SSB does not include either the first PBCH or the second PBCH, or any information in the second PBCH.

The SSB includes the first PBCH as follows: the SSB only includes the first PBCH, and does not include other PBCHs such as the second PBCH.

In an instance, the measurement configuration information is MeasObjectNR.

In some possible embodiments, after the notification information is received from one or more first network devices 101-1 by the second network device 101-2 and whether the SSB at the SSB frequency of the to-be-measured cell includes the PBCH or the first PBCH is determined, the indication information of each to-be-measured cell is set in the measurement configuration information. In this way, the measurement configuration information includes one or more pieces of indication information. Each piece of indication information corresponds to one to-be-measured cell. That is, one piece of indication information corresponds to one to-be-measured cell.

In an instance, on a condition that the measurement configuration information is MeasObjectNR, the to-be-measured cell corresponding to the indication information is added through the parameter CellsToAddMod.

In some possible embodiments, after the notification information is received from the first network device 101-1 by the second network device 101-2 and the SSB frequency is found out, it is determined that the indication information corresponds to one SSB frequency. The to-be-measured SSB is an SSB corresponding to the SSB frequency.

In some possible embodiments, the type of the abbreviated SSB may be indicated to the user equipment by the second network device 101-2.

For instance, when the indication information corresponds to the first value, the indication information is configured to indicate that the to-be-measured SSB does not include the PBCH, and when the indication information corresponds to the second value, the indication information is configured to indicate that the to-be-measured SSB includes the first PBCH.

S203, measurement is conducted by the user equipment 102 according to the measurement configuration information.

The SSB-ToMeasure parameter in MeasObjectNR only indicates some SSB indexes and does not indicate all SSB indexes corresponding to beams. Thus, in some possible embodiments, when the measurement configuration information includes one or more pieces of indication information and each piece of indication information corresponds to one to-be-measured cell, the SSBs corresponding to all the SSB indexes in an SS/PBCH block measurement time configuration (SMTC) window are measured. The SSB is the SSB on the to-be-measured cell corresponding to the indication information. That is, the user equipment determines that the SSB-ToMeasure parameter in the MeasObjectNR is not applicable to the to-be-measured cell.

In some possible embodiments, the indication information corresponds to one SSB frequency. The to-be-measured SSB is an SSB corresponding to the SSB frequency. The SSBs corresponding to all the SSB indexes in the SMTC window are measured. The SSB is the SSB at the SSB frequency.

In some possible embodiments, on a condition that the indication information corresponding to the to-be-measured cell indicates that the to-be-measured SSB does not include the PBCH, it is determined that a PSS and an SSS of the to-be-measured SSB occupy two consecutive symbols in a time domain. Compared with the method in which a PSS and an SSS in an NR R15/R16 protocol are distributed on inconsecutive symbols in a time domain, in the disclosure, the PSS and the SSS of the to-be-measured SSB occupy two consecutive symbols in a time domain, such that symbols that are not divided by the PSS and the SSS can be used for consecutive uplink and downlink transmission, and time domain resources can be reduced.

In some possible embodiments, on a condition that a frequency of the to-be-measured SSB is on a synchronization channel frequency grid, the SSB is the SSB in the NR R15/R16protocol, which can provide a function of initial access, such that idle user equipment can conveniently conduct initial access according to a synchronization signal after finding the synchronization signal in the synchronization grid. In this case, on a condition that the frequency of the to-be-measured SSB is on the synchronization channel frequency grid, the indication information is ignored, and it is determined that the to-be-measured SSB includes the second PBCH.

On a condition that the frequency of the to-be-measured SSB is not on the synchronization channel frequency grid, the idle user equipment does not conduct initial access through an SSB at the frequency, so the SSB does not need to carry information related to initial access, may not include the PBCH, or only includes the first PBCH. In this case, on a condition that the frequency of the to-be-measured SSB is not on the synchronization channel frequency grid, it is determined that the to-be-measured SSB does not include the PBCH or only includes the first PBCH according to the indication information.

In the examples of the disclosure, on a condition that the to-be-measured SSB used by a first network device for SSB broadcasting does not include the PBCH or only includes the first PBCH, the first network device notifies the second network device of the situation, and the measurement configuration information is transmitted to the user equipment by the second network device, such that the user equipment receives the to-be-measured SSB and then measures one or more to-be-measured cells under the first network device according to a characteristic of the to-be-measured SSB. Compared with a case that the to-be-measured SSB used by the first network device for SSB broadcasting includes the second PBCH, in the disclosure, the first network device can be prevented from broadcasting some unnecessary information, and energy consumption of the first network device can be reduced.

### INDUSTRIAL APPLICABILITY

A first network device can be prevented from broadcasting some unnecessary information, and energy consumption of the first network device can be reduced.

1. A method for receiving measurement configuration information, performed by user equipment, comprising:
receiving measurement configuration information transmitted by a second network device, wherein the measurement configuration information comprises indication information, wherein
the indication information is configured to indicate that a to-be-measured synchronization signal and PBCH block (SSB) does not comprise a physical broadcast channel (PBCH), or
the indication information is configured to indicate that a to-be-measured SSB comprises a first PBCH, and the first PBCH comprises less information than a second PBCH.

2. The method according to claim 1, wherein the measurement configuration information comprises one or more pieces of the indication information, and one piece of the indication information corresponds to one to-be-measured cell.

3. The method according to claim 2, further comprising:
measuring SSBs corresponding to all SSB indexes in an SSB measurement time configuration (SMTC) window, wherein the SSB is an SSB on a to-be-measured cell corresponding to the indication information.

4. The method according to claim 2, further comprising:
determining, on a condition that the indication information indicates that the to-be-measured SSB does not comprise the PBCH, that a primary synchronization signal (PSS) and a secondary synchronization signal (SSS) of the to-be-measured SSB occupy two consecutive symbols in a time domain.

5. The method according to claim 1, wherein the indication information corresponds to one SSB frequency, and the to-be-measured SSB is an SSB corresponding to the SSB frequency.

6. The method according to claim 5, further comprising: measuring SSBs corresponding to all SSB indexes in an SMTC window, wherein the SSB is an SSB at the SSB frequency.

7. The method according to claim 1, wherein the first PBCH comprises a system frame number (SFN) and an SSB index.

8. The method according to claim 1, wherein the first PBCH occupies one or two symbols in a time domain.

9. The method according to claim 1, further comprising:
ignoring the indication information on a condition that a frequency of the to-be-measured SSB is on a synchronization channel frequency grid, and determining that the to-be-measured SSB comprises the second PBCH.

10. The method according to claim 1, further comprising:
determining, on a condition that a frequency of the to-be-measured SSB is not on a synchronization channel frequency grid, that the to-be-measured SSB does not comprise the PBCH according to the indication information, or determining that the to-be-measured SSB comprises the first PBCH according to the indication information.

11. A method for transmitting measurement configuration information, performed by a second network device, comprising:
transmitting the measurement configuration information to user equipment, wherein the measurement configuration information comprises indication information, wherein the indication information is configured to indicate that a to-be-measured synchronization signal and PBCH block (SSB) does not comprise a PBCH, or the indication information is configured to indicate that a to-be-measured SSB comprises a first PBCH, and the first PBCH comprises less information than a second PBCH.

12. The method according to claim 11, further comprising:
receiving notification information transmitted by a first network device, wherein the notification information is configured to indicate that an SSB on at least one cell or at one SSB frequency corresponding to the first network device does not comprise a PBCH, or the notification information is configured to indicate that an SSB on at least one cell or at one SSB frequency corresponding to the first network device comprises the first PBCH.

13. The method according to claim 12, wherein the at least one cell is a to-be-measured cell, and the notification information comprises an identifier of at least one to-be-measured cell.

14. The method according to claim 12, wherein the notification information comprises one SSB frequency, and the at least one cell is at least one cell corresponding to the one SSB frequency.

15. The method according to claim 11, wherein the first PBCH comprises a system frame number (SFN) and an SSB index.

16. The method according to claim 11, wherein the first PBCH occupies one or two symbols in a time domain.

17. (canceled)

18. (canceled)

19. A communication apparatus, comprising one or more processors and a memory, wherein
the memory is configured to store a computer program; and
the one or more processors are collectively configured to execute the computer program, so as to:
receive measurement configuration information transmitted by a second network device, wherein the measurement configuration information comprises indication information, wherein
the indication information is configured to indicate that a to-be-measured synchronization signal and PBCH block (SSB) does not comprise a physical broadcast channel (PBCH), or
the indication information is configured to indicate that a to-be-measured SSB comprises a first PBCH, and the first PBCH comprises less information than a second PBCH.

20. A communication apparatus, comprising one or more processors and a memory, wherein
the memory is configured to store a computer program; and
the one or more processors are collectively configured to execute the computer program, so as to implement the method according to claim 11.

21. A non-transitory computer-readable storage medium, storing an instruction, wherein when the instruction is invoked and executed in a computer, the computer is caused to execute the method according to claim 1.

22. A non-transitory computer-readable storage medium, storing an instruction, wherein when the instruction is invoked and executed in a computer, the computer is caused to execute the method according to claim 11.
